(19) United States
(12) Patent Application Publication
(10) Pub. No.: US 2012/0216537 A1
(43) Pub. Date: Aug. 30, 2012

(54) Solar Receiver

(76) Inventor: John S. Fitch, Los Altos, CA (US)

(21) Appl. No.: 13/037,246

(22) Filed: Feb. 28, 2011

(51) Int. Cl. F03G 6/04; F02C 1/05; F24J 2/24; F24J 2/48; B28B 3/02; B29C 35/02

(52) U.S. Cl. 60/641.12; 264/29.1; 126/658; 126/676; 60/650; 60/682

(57) ABSTRACT

A solar receiver for a solar thermal power system includes a silicon carbide body having a passage therethrough. A coating on an outer surface of the silicon carbide body may increase absorption of solar radiation relative to the silicon carbide body. A plurality of silicon carbide fins may extend outwardly from the silicon carbide body, the fins oriented such that when the receiver is placed on a tower of a solar thermal power system having a plurality of heliostats, the fins are substantially perpendicularly to solar radiation received on the silicon carbide body from the plurality of heliostats.

### TECHNICAL FIELD

The present disclosure relates generally to solar receivers for concentrated solar thermal power systems.

### BACKGROUND

A concentrated solar thermal power system generally includes multiple heliostats configured to reflect light onto a solar receiver. The resulting heat can then be converted into power. For example, the concentrated solar energy can heat a fluid as air, water or molten salt, and the heated fluid can travel through a heat exchanger to heat water, producing steam which passes through a steam turbine to generate electricity. Due to the concentrated solar energy from the multiple heliostats, a solar receiver often operates at temperatures of nearly 1000° C.

### SUMMARY

A solar receiver can be formed of silicon carbide (SiC), which can accept intense solar radiation and provide good thermal conductivity to transfer heat to a working fluid. In addition, such a solar receiver can withstand high operating temperatures and pressures. The solar receiver can be constructed with a simple mechanical design, e.g., with vertical passages through a block of SiC material. The receiver can be formed by placing carbonaceous powder in a mold, compressing the powder in the mold, firing the compressed powder to form a carbon matrix, and infiltrating the carbon matrix with molten silicon.

In one aspect, a solar receiver for a solar thermal power system includes a silicon carbide body having a passage therethrough and a coating on an outer surface of the silicon carbide body to increase absorption of solar radiation relative to the silicon carbide body.

Implementations can include one or more of the following features. The coating may increase absorption of visible light or infrared light relative to the silicon carbide body. There may be a sealant on an outer surface of the silicon carbide body. A plurality of fins may extend from the silicon carbide body inwardly into the passage. A plurality of silicon carbide fins may extend outwardly from the silicon carbide body.

In another aspect, a solar receiver includes a silicon carbide body having a passage therethrough and a plurality of silicon carbide fins extending outwardly from the silicon carbide body, the fins oriented such that when the receiver is placed on a tower of a solar thermal power system having a plurality of heliostats, the fins are substantially perpendicularly to solar radiation received on the silicon carbide body from the plurality of heliostats.

Implementations can include one or more of the following features. There may be a coating on an outer surface of the silicon carbide body to increase absorption of solar radiation relative to the silicon carbide body. There may be a sealant on an outer surface of the silicon carbide body. A plurality of fins may extend from the silicon carbide body inwardly into the passage.

In another aspect, a method of forming a solar receiver for a solar thermal power system includes placing a carbonaceous powder in a mold, compressing the powder in the mold to create a body having a passage therethrough, firing the body to create a body having a carbon matrix having the passage, infiltrating molten silicon into the carbon matrix of the body to create a silicon carbide body having the passage, and forming a coating on an outer surface of the silicon carbide body to increase absorption of solar radiation relative to the silicon carbide body.

Implementations can include one or more of the following features. Firing the body may occur in a nitrogen atmosphere. A resin may be placed in the mold with the carbonaceous powder, and the compressing step may cure the resin.

In another aspect, a solar thermal power system includes a compressor to generate pressurized gas, a silicon carbide solar receiver having at least one passage therethrough, an inlet of the passage coupled to the compressor to receive the pressurized gas, a plurality of heliostats to direct sunlight to the silicon carbide solar receiver to heat the pressurized gas to generate heated pressurized gas, and a turbine coupled to an outlet of the passage of the silicon carbide solar receiver to receive the heated pressurized gas and generate electrical power.

Implementations can include one or more of the following features. The gas may be air. A controller may be coupled to the compressor, the plurality of heliostats, and the turbine. The controller may be configured to cause the compressor to generate the pressurized gas with a pressure of 5 to 20 atmospheres. The controller may be configured to cause the plurality of heliostats to focus sufficient sunlight on the receiver such that the heated pressurized gas has a temperature of 900 to 1000° C. There may be a coating on an outer surface of the silicon carbide body to increase absorption of solar radiation relative to the silicon carbide body. There may be a sealant on an outer surface of the silicon carbide body. The solar receiver may include a plurality of silicon carbide fins extending outwardly from the silicon carbide body oriented substantially perpendicularly to the reflected solar radiation received from the plurality of heliostats. A majority of the heliostats may be on a first side of the solar receiver, the solar receiver may include a plurality of parallel passages formed therethrough, and the plurality of passages may be more closely spaced on the first side of the solar receiver than on a second opposite side of the solar receiver.

In another aspect, a method of operating a solar thermal power system includes compressing a gas to generate a pressurized gas, flowing the pressurized gas through a passage in a silicon carbide solar receiver, heating the pressurized gas by directing sunlight from a plurality of heliostats onto the silicon carbide solar receiver to generate heated pressurized gas, and directing the heated pressurized gas through a turbine to generate electrical power.

Implementations can include one or more of the following features. The gas may be air. Compressing the gas may generate the pressurized gas with a pressure of 5 to 20 atmospheres. Heating the pressurized gas may generate the heated pressurized gas with a temperature of 900 to 1000° C. Solar radiation may be captured with a coating applied to an outer surface of the silicon carbide body that increases absorption of solar radiation relative to the silicon carbide body. Solar radiation may be captured with a plurality of silicon carbide fins extending outwardly from the silicon carbide body oriented substantially perpendicularly to the reflected solar radiation received from the plurality of heliostats. The gas may be flowed through a plurality of passages that are more closely spaced on a first side of the solar receiver that is closer to a majority of the heliostat than on a second opposite side of the solar receiver.

Potential advantages of implementations may include the following. A silicon carbide solar receiver can absorb intense solar radiation, provide good thermal conductivity to transfer the heat to a working fluid, and withstand high operating temperatures and pressures. The method of manufacturing the silicon carbide solar receiver permits it to be fabricated at relatively low cost. The simple mechanical design of the solar receiver can reduce installation and maintenance costs.

The details of one or more implementations are set forth in the accompanying drawings and the description below. Other aspects, features, and advantages will become apparent from the description, the drawings, and the claims.

### BRIEF DESCRIPTION OF THE DRAWINGS

FIG. 1 is a schematic diagram of a heliostat system.

FIG. 2 is a schematic diagram of a heat engine.

FIG. 3 is a schematic diagram of a solar receiver.

FIG. 4 is a schematic diagram of a vertical cross-section through a solar receiver.

FIG. 5 is a schematic diagram of a horizontal cross-section through a solar receiver.

FIG. 6 is a schematic diagram of a horizontal cross-section through another implementation of a solar receiver.

Like reference numbers and designations in the various drawings indicate like elements.

### DETAILED DESCRIPTION

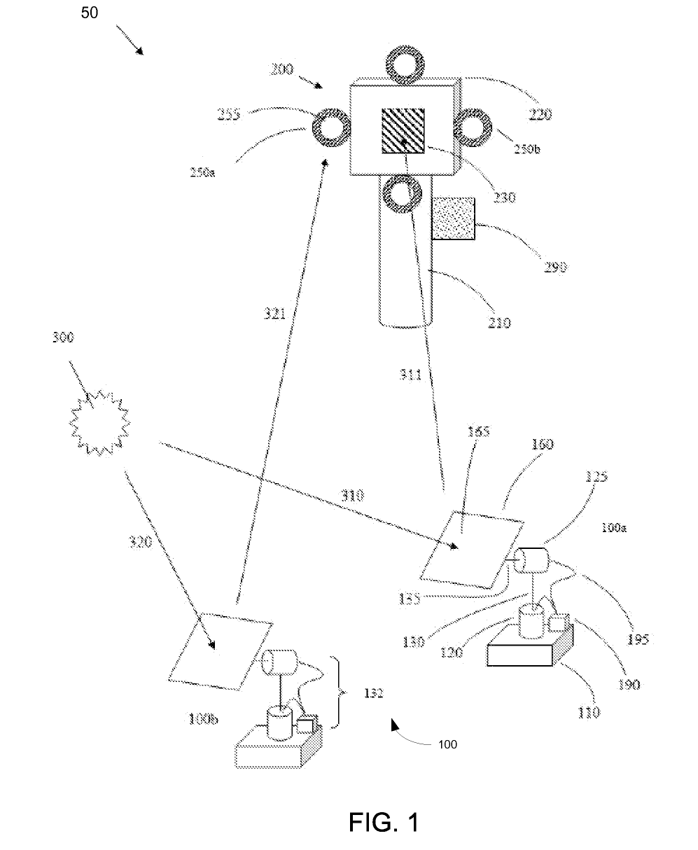

Referring to FIG. 1, a concentrated solar thermal power system 50, e.g., a solar power plant, includes a field of heliostats 100, which can include up to hundreds or thousands of heliostats (only two heliostats 100a, 100b are shown in FIG. 1), and a heat engine that includes a solar receiver 230 supported on a central tower 200 to receive light reflected from the heliostats 100.

Each heliostat 100 includes a mirror 160 having a reflective surface 165 on the face of the mirror 160 closest to the sun 300. The reflective surface 165 can be flat or curved. The mirror 160 can rest on a foundation 110, which can be partially below ground.

An actuation system 132 is configured to move the heliostat mirror 160. The actuation system 132 can include multiple motors, such as a motor 120 to move the heliostat 100 in the azimuth direction using a motor shaft 130, and a motor 125 to adjust the altitude, i.e., angle of elevation, of the heliostat using a motor shaft 135. The actuation system 132 further includes control circuitry 190, e.g., a programmed microprocessor and a transceiver, to receive commands directing the movement of the mirror 160. Wires 195 can electrically connect the control circuitry 190 with the motors 120, 125, and the microprocessor can convert the commands received by transceiver into voltage signals on the wires 195 to control the motors 120, 125 and thus to control the orientation of the mirror 160. In other implementations, the actuation system can include hydraulic, pneumatic, cable and pulley, ballasted, or ball and socket mechanisms to move the heliostat mirror in the azimuth direction and/or to adjust the altitude.

The tower 200 can include a support structure 210 that supports a housing 220 in which the receiver 230 is located. One or more cameras 250a, and 250b, which can optionally include a filtering element 255 to reduce the intensity of the sunlight, can also be located on the tower, e.g., in or on the housing 220. The region in which the receiver 230 is located can be called the “receiver volume” or the “hot region” of the tower 200. The receiver 230 can be located inside the housing 220.

In operation, sunlight rays 320, 310 from the sun 300 can strike the reflective surface 165 of the heliostat mirrors 160. The reflective surface 165 can then reflect rays 321, and 311 towards the receiver 230. The reflected rays 321, and 311, in addition to rays reflected from other heliostats in the field, can heat the receiver 230 to temperatures of between 900° C. and 1200° C., such as between 950° C. and 1150° C. The heat can be used to drive the heat engine to produce power. For example, the heat can be used to warm cold air, which can then be expanded through a turbine engine which turns a generator shaft, which creates power. The more concentrated the sunlight is in the receiver 230, the higher the temperature of the receiver 230, and the more efficient the power generation of the system 50 can be.

In order to maximize the concentration of rays on the receiver 230, the normal vector of the reflective surface 165 must bisect the angle between the rays 310, and 320 from the sun and the rays reflected towards the center of the receiver 230. Thus, as the sun 300 moves across the sky, the orientation of the reflective surface 165 of the mirrors 160 can be adjusted to ensure that the reflected rays are hitting the receiver 230 without causing too much spillage, i.e., causing too many rays to be reflected outside of the receiver 230.

The control system of the concentrated solar thermal power system 500 further includes a programmed microprocessor or computer 290 to receive image data from the camera 250, to compute the movement of any heliostat mirrors 160 necessary to keep the heliostat oriented to reflect light to the receiver 230, and to send commands to the transceivers 190 of the heliostats. Although the computer 290 is shown as attached to the tower, this is not necessary. The computer 290 includes its own transceiver to communicate with the transceivers 190 of the heliostats 100. The connection between the transceivers 290 and 190 can be wired or wireless.

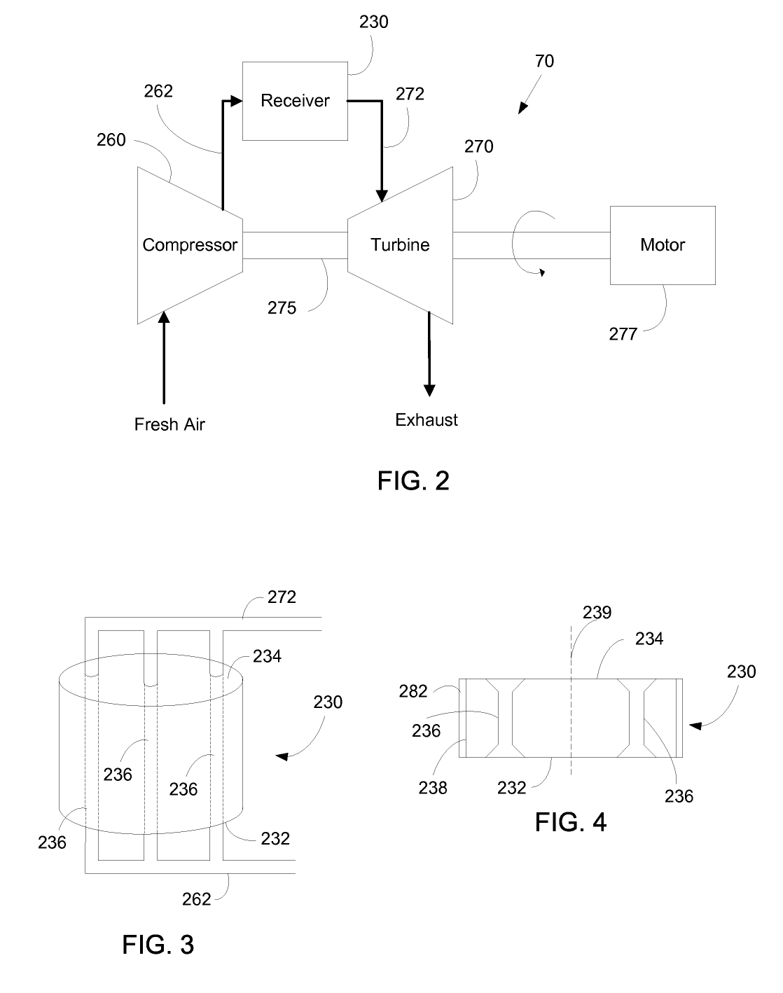

Referring to FIG. 2, the heat engine 70 can be a Brayton turbine engine, and can include a compressor 260, the receiver 230, and a turbine 270. A gas, e.g., air from the atmosphere, enters the compressor 260 and is compressed to provide pressurized gas. The pressurized gas can be at a pressure of 5-20 atmospheres. The pressurized gas flows through one or more passages in the solar receiver 230, which heats the pressurized gas to generate heated pressurized gas. The pressurized gas can be heated to a temperature of 900 to 1000° C. The heated pressurized gas is directed through the turbine 270 to generate electrical power, e.g., by turning a drive shaft 275 connected to an electrical motor 277. The turbine 270 can also power the compressor 260.

Referring to FIG. 3, the receiver 230 can be a right solid, e.g., a generally cylindrical body or a right prism. The receiver 230 can be made of a homogenous material, e.g., silicon carbide, and can be a unitary body, e.g., a single part without gaps, breaks, seams or the like. The receiver includes a bottom surface 232 and a top surface 234. The receiver 230 includes one or more passages 236, e.g., a plurality of passages, formed therethrough (although three passages are shown in FIG. 3, there could be four or more passages, or just one or two passages). The passages 236 can extend in parallel. The passages 236 can extend vertically through the receiver 230 from the bottom surface 232 to the top surface 234. In some implementations, the passages are not interconnected within the body of the receiver 230. The height of the receiver 230, i.e., in the direction parallel to the passages, can be less than the width of the receiver, i.e., in the direction perpendicular to the passages.

An inlet pipe 262 can connect the output of the compressor 260 to one end of the passages 236, e.g., at the bottom surface 232, and an outlet pipe 272 can connect the other end of the passages 236, e.g., at the top surface 234, to the inlet of the turbine 270. Thus, in operation, compressed gas, e.g., air, from the compressor 260 flows upward through the passages 236 in the receiver. The compressed gas in the passages 236 absorbs heat from the receiver 230, and then exits the receiver 230 to power the turbine 270.

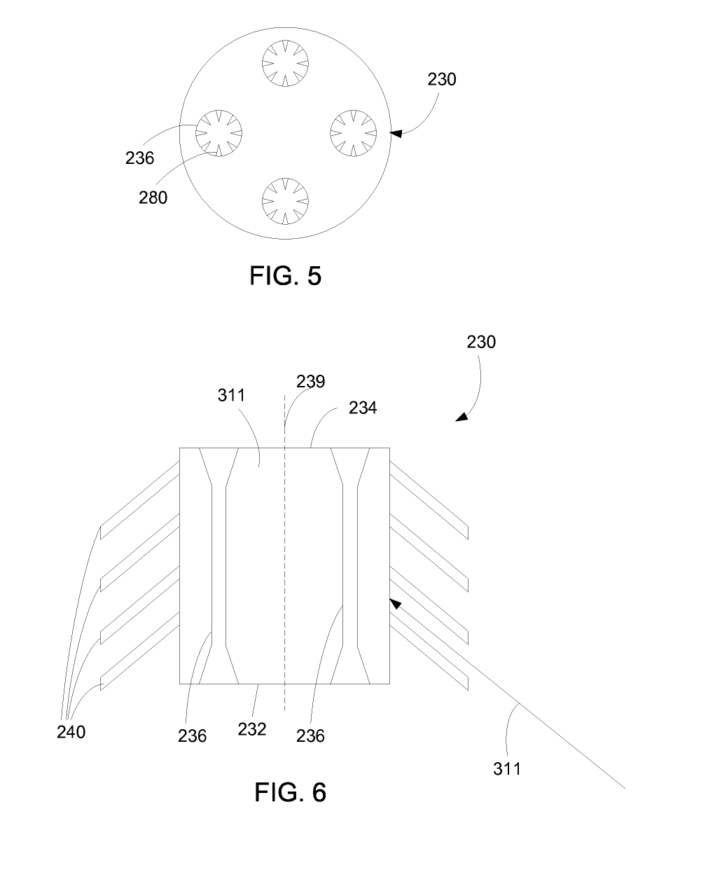

Referring to FIGS. 4 and 5, the receiver 230 includes multiple vertical passages 236. The passages 236 can be spaced at equal angular intervals around the central axis 239 of the receiver 230. Alternatively, assuming that a majority of the heliostats are on a first side of the receiver 230, the passages may be more closely spaced on the first side of the receiver 230 than on a second opposite side of the receiver. The passages 236 can be positioned relatively closer to the outer surface 238 of the receiver 230 than the central axis 239. Multiple fins 280 can project from the body of the receiver inwardly into each passage 236 in order to increase heat transfer from the receiver to the gas flowing in the passage 236. The fins 280 can be spaced at equal angular intervals around the central axis of the passage 236. The fins 280 can be projections of the unitary body of the receiver 230.

The receiver 230 can be a silicon carbide body. Silicon carbide can absorb intense solar radiation, provide good thermal conductivity to transfer the heat to the gas flowing through the passage, and withstand high operating temperatures and pressures.

One or more surfaces of the receiver 230, e.g., the outer surface 238, can be treated, e.g., coated with a layer 282 or chemically modified to form a layer 282, to modify the absorption or emissivity of the surfaces (relative to the material, e.g., silicon carbide, of the body of the receiver). For example, the outer surface 238 can be treated to increase absorption of sunlight, e.g., to increase absorption of visible light and/or infra-red radiation. For example, the outer surface 238 can be coated with an anti-reflective film. As another example, the outer surface 238 can be treated to decrease emission at the expected operating temperature, e.g., 900 to 1000° C., of the receiver 230. The layer 282 can directly contact the silicon carbide body of the receiver 230.

One or more surfaces of the receiver 230, e.g., the bottom surface 232, the top surface 234 and the outer surface 238, can be treated, e.g., coated with a layer or chemically modified, to reduce leakage of the fluid in the passages, e.g., if the material of the receiver 230 is porous or otherwise permeable to the fluid. For example, the bottom surface 232, the top surface 234 and the outer surface 238 can all be coated with a sealant. For example, the receiver 230 may be coated with a layer of pryrolytic carbon, e.g., by chemical vapor deposition. However, a silicon carbide receiver 230 may be generally impermeable, and may not need a sealant. If sealing layer is present, it can be above or below the layer that modifies the absorption or emissivity of the surface.

In some implementations, as shown in FIG. 6, the receiver 230 includes one or more fins 240 projecting outwardly from a main body 242. The fins can be oriented such that when the receiver 230 is placed on the tower 200, the fins are substantially perpendicularly to the rays 311, 321 of solar radiation received on the silicon carbide body of the receiver 230 from the plurality of heliostats 100. For example, the fins 240 can project at a downward angle relative to the central axis 239 of the receiver. In some implementations, the fins 240 can be annular flanges extending around the main body 242 of the receiver. The fins 240 can be formed of silicon carbide. The fins 240 can be formed integrally (i.e., without a discernable joint) with the main body 242, e.g., by being formed in the same mold. Alternatively, the fins 240 can be attached to the outer surface 238 of the main body 242, e.g., by adhesive. The outer surfaces of the fins 240 can be treated, e.g., coated with a layer or chemically modified, to increase the absorption the surfaces (relative to the material, e.g., silicon carbide, of the body of the receiver). Without being limited to any particular theory, heat radiated in most directions by one fin is absorbed by other fins, thus tending to increase the effective absorption of the receiver.

To fabricate a silicon carbide solar receiver, a carbonaceous powder is placed into a mold. The carbonaceous powder can be, for example, a wood powder. The powder can be mixed, while in the mold or prior to being placed into the mold, with a resin, e.g., a phenolic resin, to improve the cohesion of the body after compression. Additional fillers, such as carbon fibers, can also be mixed with the carbonaceous powder.

The powder, along with any resin and filler, is compressed in the mold to form a pressed body. The pressed body can have the eventual shape of the receiver. That is, since the shape of the pressed body is complementary to the shape of the mold, the mold can include projections which define the passages through the body. For example, a plurality of parallel projections in the mold can result in a body having a plurality of parallel passages. Optionally, the compression process can cure the resin. The pressed body is removed from the mold. Alternatively or in addition to forming passages by molding, some passages may be machined through the compressed body, e.g., by drilling, grinding or the like. Optionally, multiple pressed bodies can be stacked and adhered, e.g., with a wood glue, in order to increase the height of the receiver.

The pressed body is then fired to convert the carbonaceous powder into carbon/carbon. This creates a porous carbon matrix body having the plurality of parallel passages. For example, the body can be heated to 1650° C. The body can be fired in a nitrogen atmosphere.

The carbon matrix body is then infiltrated with molten silicon to create the silicon carbide body having the plurality of parallel passages. For example, the carbon matrix body can be placed in direct contact with a carbon matrix wick, and the carbon matrix wick can be placed into a bath of the molten silicon. The molten silicon would thus wick through the carbon matrix wick into the carbon matrix body. After cooling, the silicon carbide body can be ready for use, although additional treatments such as the sealant and/or the modification of the absorption or emissivity of the surfaces can be performed.

Although the heat engine discussed above uses a gas, e.g., air, another fluid could be heated to drive the turbine. The fluid could stay in the same phase when heated in the receiver, or the fluid could undergo a phase change when heated in the receiver. For example, the working fluid could be water, e.g., liquid water in the receiver could be boiled by the heat to generate water vapor to drive the turbine. In addition, although the heat engine discussed above directly heats the working fluid, the receiver could heat a first fluid, e.g., water or molten salt, and then transfer the heat to a second working fluid, e.g., with a heat exchanger. In addition, although the heat engine discussed above expels the exhaust into the atmosphere, the working fluid could pass through a heat exchanger to expel the heat into the environment, and the cooled working fluid could be returned to the compressor.

Particular implementations have been described. Other implementations are within the scope of the following claims.

What is claimed is:

1. A solar receiver for a solar thermal power system, comprising:
a silicon carbide body having a passage therethrough; and
a coating on an outer surface of the silicon carbide body to increase absorption of solar radiation relative to the silicon carbide body.

2. The solar receiver of claim 1, wherein the coating increases absorption of visible light relative to the silicon carbide body.

3. The solar receiver of claim 1, wherein the coating increases absorption of infrared light relative to the silicon carbide body.

4. The solar receiver of claim 1, further comprising a sealant on an outer surface of the silicon carbide body.

5. The solar receiver of claim 1, further comprising a plurality of fins extending from the silicon carbide body inwardly into the passage.

6. The solar receiver of claim 1, further comprising a plurality of silicon carbide fins extending outwardly from the silicon carbide body.

7. A solar receiver, comprising:
a silicon carbide body having a passage therethrough and a plurality of silicon carbide fins extending outwardly from the silicon carbide body, the fins oriented such that when the receiver is placed on a tower of a solar thermal power system having a plurality of heliostats, the fins are substantially perpendicularly to solar radiation received on the silicon carbide body from the plurality of heliostats.

8. The solar receiver of claim 7, further comprising a coating on an outer surface of the silicon carbide body to increase absorption of solar radiation relative to the silicon carbide body.

9. The solar receiver of claim 7, further comprising a sealant on an outer surface of the silicon carbide body.

10. The solar receiver of claim 7, further comprising a plurality of fins extending from the silicon carbide body inwardly into the passage.

11. A method of forming a solar receiver for a solar thermal power system, comprising:
placing a carbonaceous powder in a mold;
compressing the powder in the mold to create a body having a passage therethrough;
firing the body to create a body having a carbon matrix having the passage;
infiltrating molten silicon into the carbon matrix of the body to create a silicon carbide body having the passage; and
forming a coating on an outer surface of the silicon carbide body to increase absorption of solar radiation relative to the silicon carbide body.

12. The method of claim 11, wherein firing the body occurs in a nitrogen atmosphere.

13. The method of claim 11, further comprising placing a resin in the mold with the carbonaceous powder, and wherein the compressing step cures the resin.

14. A solar thermal power system, comprising:
a compressor to generate pressurized gas;
a silicon carbide solar receiver having at least one passage therethrough, an inlet of the passage coupled to the compressor to receive the pressurized gas;
a plurality of heliostats to direct sunlight to the silicon carbide solar receiver to heat the pressurized gas to generate heated pressurized gas; and
a turbine coupled to an outlet of the passage of the silicon carbide solar receiver to receive the heated pressurized gas and generate electrical power.

15. The solar thermal power system of claim 14, wherein the gas is air.

16. The solar thermal power system of claim 15, further comprising a controller coupled to the compressor, the plurality of heliostats, and the turbine.

17. The solar thermal power system of claim 16, wherein the controller is configured to cause the compressor to generate the pressurized gas with a pressure of 5 to 20 atmospheres.

18. The solar thermal power system of claim 16, wherein the controller is configured to cause the plurality of heliostats to focus sufficient sunlight on the receiver such that the heated pressurized gas has a temperature of 900 to 1000° C.

19. The solar thermal power system of claim 14, further comprising a coating on an outer surface of the silicon carbide body to increase absorption of solar radiation relative to the silicon carbide body.

20. The solar thermal power system of claim 14, further comprising a sealant on an outer surface of the silicon carbide body.

21. The solar thermal power system of claim 14, wherein the solar receiver includes a plurality of silicon carbide fins extending outwardly from the silicon carbide body oriented substantially perpendicularly to the reflected solar radiation received from the plurality of heliostats.

22. The solar thermal power system of claim 14, wherein a majority of the heliostats are on a first side of the solar receiver, the solar receiver includes a plurality of parallel passages formed therethrough, and the plurality of passages are more closely spaced on the first side of the solar receiver than on a second opposite side of the solar receiver.

23. A method of operating a solar thermal power system, comprising:
compressing a gas to generate a pressurized gas;
flowing the pressurized gas through a passage in a silicon carbide solar receiver;
heating the pressurized gas by directing sunlight from a plurality of heliostats onto the silicon carbide solar receiver to generate heated pressurized gas; and
directing the heated pressurized gas through a turbine to generate electrical power.

24. The method of claim 23, wherein the gas is air.

25. The method of claim 23, wherein compressing the gas generates the pressurized gas with a pressure of 5 to 20 atmospheres.

26. The method of claim 23, wherein heating the pressurized gas generates the heated pressurized gas with a temperature of 900 to 1000° C.

27. The method of claim 23, further comprising capturing solar radiation with a coating applied to an outer surface of the silicon carbide body that increases absorption of solar radiation relative to the silicon carbide body.

28. The method of claim 23, further comprising capturing solar radiation with a plurality of silicon carbide fins extending outwardly from the silicon carbide body oriented substantially perpendicularly to the reflected solar radiation received from the plurality of heliostats.

29. The method of claim 23, further comprising flowing the gas through a plurality of passages that are more closely spaced on a first side of the solar receiver that is closer to a majority of the heliostat than on a second opposite side of the solar receiver.
